(19) United States
(12) Patent Application Publication
(10) Pub. No.: US 2015/0182982 A1
(43) Pub. Date: Jul. 2, 2015

(54) INSERT AND HOLDER FOR A METERING DEVICE

(71) Applicant: BTG IPI, LLC, De Pere, WI (US)

(72) Inventors: Ari Rousu, Greenwell Springs, LA (US); Eric Fiel, Sobieski, WI (US); Richard Lauterbach, Destin, FL (US); Thomas Lauterbach, Appleton, WI (US)

(73) Assignee: BTG IPI, LLC, De Pere, WI (US)

(21) Appl. No.: 14/407,246

(22) PCT Filed: Jun. 11, 2013
(86) PCT No.: PCT/US2013/045098

§ 371 Date: Dec. 11, 2014

Related U.S. Application Data
(60) Provisional application No. 61/657,973, filed on Jun. 11, 2012.

(51) Int. Cl. B05C 3/02; B05C 13/00

(52) U.S. Cl. CPC B05C 3/02; B05C 13/00

(57) ABSTRACT

A holder and an insert for a metering device for coating liquid or viscous coating medium onto a moving material web. The holder being elongated and including an insert groove, a locking rod groove and a locking rod being movably received in the locking rod groove and being formed with locking portions adapted to project through a slot and with releasing portions. The insert being elongated and including a coating rod groove being adapted to rotatably support a coating rod, and one or more engagement formations being adapted to interact with the locking rod to allow the insert to be inserted into and released from the insert groove when the locking rod is in a releasing position, and to allow secure holding of the insert in the insert groove when the locking rod is in a locking position, in which the engagement formations is in engagement with the locking rod.

### TECHNICAL FIELD

The present invention relates to an insert for rotatably supporting a coating rod as well as a holder for mounting of the insert and the coating rod, which are parts of a metering device for coating liquid or viscous coating medium onto a moving material web.

### BACKGROUND OF THE INVENTION

Metering devices for coating liquid or viscous coating mediums onto a moving web, either directly or indirectly via a transfer roller, are well known in the art. Especially within the paper manufacturing industry where paper webs often are coated with coloring substances, sizing agents and the like. The coating medium may optionally be applied directly onto the moving web or be applied to a transfer roller, which in its turn transfers the coating medium onto the web. The coating medium is supplied by means of some kind of coating feeder, which applies the coating medium to the web or to the transfer roller. The metering device is positioned downstream from the coating feeder as seen in the direction of the moving web and/or the transfer roller and meters the coating layer by means of a rotating cylindrical coating rod, which is supported in the metering device and which is pressed with a force towards the web/transfer roller. By regulating the pressing force of the coating rod towards the web/transfer roller, it is possible to control the thickness of the coated layer.

In a most common design of a metering device, the coating rod is installed directly into a supporting holder which is attached to some kind of framework. However, the rotating action of the coating rod causes wear of the coating rod and the circular shaped bed or groove for the coating rod in the holder. This causes need for frequent replacement of the coating rod and the holder and since the holder is a supporting structure having a rather large overall size, the costs for each such replacement will be quite high. In order to reduce costs, a type of metering device has been developed in which the coating rod is rotatably accommodated in a coating rod groove of an insert, and the insert is in its turn accommodated in an insert groove in a holder. In this way it is possible to manufacture the coating rod and the insert, which are parts exposed to heavy wear due to the rotating operation, with rather small dimensions which will make them comparatively inexpensive to manufacture and replace. The holder, on the other hand, is not exposed to the same wear as the insert unit, i.e. the coating rod and the insert, and is accordingly dimensioned to firmly support the insert and coating rod in a well-defined position and adapted to last essentially the lifetime of the metering device.

One problem with a metering device of this kind is how to attach the insert unit in the holder since the insert has to surround the coating rod over more than 180° of its circumference and the holder must be able to hold the insert unit in a reliable way. One way to achieve this would be to slide the insert unit from one end into the insert groove in the holder. However, since a metering device of this kind has a considerable length, sometimes up to 10-12 m, such a procedure would require a lot of space and also a lot of force due to friction between the insert and the insert groove since the insert must be accommodated with rather close fit in the holder to ensure a well-defined positioning without flexing or vibrations of the coating rod for achieving a sufficient precision when applying the coating layer.

In prior art it is known to make the insert somewhat elastic such that the coating rod groove in the insert can be opened up a bit and the coating rod inserted sideways into the coating rod groove of the insert. Also, the holder is made somewhat elastic, by means of a weakening portion or the like, such that the insert groove in the holder can be slightly opened up and also the insert unit can be inserted sideways into the insert groove of the holder. In order to ensure firm attachment of the insert unit in the insert groove of the holder, a compressed-air hose is arranged in the holder which, when supplied with compressed air, will act on the holder to close the insert groove around the insert unit. Such metering devices are disclosed in for example WO 03/078077 and WO 05/033407. One disadvantage with such a structure is that it has a built in weakness in its structure and is therefore totally dependent on supply of compressed air. Accordingly, in case of failure of the compressed air supply, the insert unit can accidentally be detached from the holder.

In WO 07/063183 is disclosed a metering device in which the holder is made of a rigid material and has no weakening portion to allow open up of the insert groove. In order to be able to install the insert into the insert groove of the holder, the coating rod has to be removed from the insert such that the insert can be compressed and accommodated in the insert groove. To subsequently allow insertion of the coating rod into the coating rod groove, the insert has to be made of a resilient material such that it can be deformed when pushing the coating rod into the coating rod groove. Such a metering device can advantageously dispense with any compressed-air hose. However, the resilient properties of the insert could affect the positioning precision for the coating rod in an unfavorable way. Also, to push a very long coating rod of several meters of length into a narrow coating rod groove by hand may cause difficulties. Moreover, the attachment is probably not so reliable since a force of the same size but in the opposite direction, could accidentally release the coating rod from the coating rod groove again.

Also other types of metering devices are known in prior art. As examples can be mentioned a type where the insert is attached to the holder by means of a T-formed or wedge-formed strip of the holder which is inserted into a mating groove in the insert by sliding the insert sideways. One disadvantage with such a solution is that a play inevitable appears in such a structure which might deteriorate the well-defined positioning of the coating rod. Also, since the insert is not enclosed by the holder this must be compensated by making the insert correspondingly more rigid with increased costs as a consequence.

From WO 11/076629 it is known to attach the insert to the holder by means of at least one separate, mechanically operating locking member in form of a hook, clamp or the like. This kind of attachment is in general well functioning but has the disadvantage that it is located on the outside of the metering device which has to result that it is prone to accumulate dirt during long-term operation. It is also a disadvantage that in order to attach the insert to the holder over its entire length, it is necessary for an operator to move along the whole length of the metering device, which sometimes can be up to 10-12 m in length, to snap-in the in most cases several locking members between the holder and the insert.

### SUMMARY OF THE INVENTION

It is an object of the invention to provide an insert and a holder for a metering device by which the insert can be quickly and readily attached to the holder by means of a reliable and inexpensive locking device. At least this object is achieved by an insert, a holder and a metering device according to the claims 1, 6 and 18, respectively.

The invention is based on the insight that this object may be achieved by arranging a locking rod in a locking rod groove in and along the longitudinal direction of the holder which by a slot opens through a seating surface of an insert groove in the holder, wherein the locking rod is provided with locking portions and with releasing portions, the locking portions being adapted to project through the slot. The insert is in turn provided with one or more engagement formations arranged in the longitudinal direction of a mounting surface, which is adapted to bear against and be enclosed by the seating surface inside the insert groove of the holder. The engagement formations are adapted to interact with the locking portions of the locking rod in its locking position to lock the insert inside the insert groove, whereas when the locking rod is in its releasing position, the engagement formations are released from the locking rod and the insert can be removed from the holder.

As an example, this object may be achieved by arranging a rotary locking rod in a locking rod groove in and along the longitudinal direction of the holder which by a slot opens through a seating surface of an insert groove in the holder, wherein the locking rod is within a first part of its circumference, at least partly along its length, provided with locking portions and within a second part of its circumference, at least partly along its length, provided with releasing portions. When the locking rod is rotated to a locking position, the locking portions project through the slot, whereas when the locking rod is rotated to a releasing position, the releasing portions will coincide with the slot. The insert is in its turn provided with one or more engagement formations arranged in the longitudinal direction of a mounting surface, which is adapted to bear against and be enclosed by the seating surface inside the insert groove of the holder. The engagement formations are adapted to interact with the locking portions of the locking rod in its locking position to lock the insert inside the insert groove, whereas when the locking rod is in its releasing position, the engagement formations are released from the locking rod and the insert can be removed from the holder.

As another example, this object may be achieved by arranging a sliding locking rod in a locking rod groove in and along the longitudinal direction of the holder which by a slot opens through a seating surface of an insert groove in the holder, wherein the locking rod is, at least partly along its length, provided with locking portions and, at least partially along its length, provided with releasing portions, the locking portions projecting through the slot. The insert is in its turn provided with one or more engagement formations arranged in the longitudinal direction of a mounting surface, which is adapted to bear against and be enclosed by the seating surface inside the insert groove of the holder. The engagement formations are adapted to interact with the locking portions of the locking rod in its locking position to lock the insert inside the insert groove, whereas when the locking rod is in its releasing position, the engagement formations are released from the locking rod and the insert can be removed from the holder. When the locking rod is slid to a locking position, the positions of the locking portions will coincide with the positions of the engagement formations, whereas when the locking rod is slid to a releasing position, the positions of the releasing portions will coincide with the positions of the engagement formations.

A locking device designed in this way will have a protected position, since the locking rod is accommodated inside a locking rod groove within the holder, which has to effect that it is not prone to accumulation of dirt during operation. Also, it can be quickly and readily operated from the releasing position to the locking position and vice versa, either by hand by rotating or pushing/pulling, respectively, an operating means at one end of the metering device, or by actuating some kind of power generating means, such an electric motor or the like, for rotating or pushing/pulling, respectively, the locking rod. By the operation of the locking rod, the entire insert will be locked or released all over its length in one single operation.

The invention can be realized in many different ways within the scope of the following claims. For example, the locking rod itself as well as its locking and releasing portions and also the mating engagement portions of the insert can be formed in an almost endless number of ways.

In the simplest embodiment of a rotary locking rod, as described and illustrated hereinafter, the locking rod has a D-shape as seen in cross section, either substantially all over its entire length or only along confined portions corresponding to where the engagement portions along the insert are located. Also another five exemplary embodiments of a rotary locking rod are disclosed in the following description and drawings.

Moreover, the rotary locking rod and the corresponding locking rod groove may have many different cross sectional shapes as long as the locking rod is rotatable within the locking rod groove. For example, a circular locking rod can be rotatable within a polygonal locking rod groove and vice versa. Also a star-shaped or toothed locking rod can be rotatable inside a circular or polygonal locking rod groove.

Furthermore, the locking and releasing portions of the rotary locking rod as well as the engagement formations of the corresponding insert can optionally be composed of several portions or formations with a rather short extension in the longitudinal direction of the locking rod and the insert, respectively, or be continuously extending over substantially the entire length of the locking rod or the insert. In a conceivable embodiment, the locking rod may be formed with short portions mating with and being rotatable inside the locking rod groove, e.g. by having a circular cross section, while intermediate portions are formed with arbitrarily formed locking and releasing portions.

In the simplest embodiment of a sliding locking rod, as described and illustrated hereinafter, the locking rod has a circular shape as seen in cross section, the releasing portions being of a smaller diameter and the locking portions being of a larger diameter. Also another five exemplary embodiments of a sliding locking rod are disclosed in the following description and drawings.

Moreover, the sliding locking rod and the corresponding locking rod groove may have many different cross sectional shapes as long as the locking rod is slidable within the locking rod groove. For example, a circular or polygonal, respectively, locking rod can be slidable within a circular or polygonal, respectively, locking rod groove. Also, a circular locking rod can be slidable within a polygonal locking rod groove and vice versa. In fact, any of a circular, polygonal, star-shaped or toothed locking rod can be slidable inside a circular, polygonal, star-shaped or toothed locking rod groove.

Furthermore, the locking and releasing portions of the sliding locking rod as well as the engagement formations of the corresponding insert can be composed of several portions or formations with a rather short extension in the longitudinal direction of the locking rod and the insert, respectively. The locking and releasing portions can be alternatingly arranged along the length of the locking rod, whereas the engagement formations can be intermittently arranged along the length of the insert. In a conceivable embodiment, the sliding locking rod, such as for a locking rod of circular cross section, is as well rotatable within the locking rod groove. The releasing portions of such a rotatable sliding locking rod may be formed over the entire circumference of the rod. Thus, the releasing position of such a rotatable sliding locking rod can be made independent of the rotated position of the rod. In another conceivable embodiment, the sliding locking rod, such as for a locking rod of polygonal cross section received in a locking rod groove of a similar cross section, is not rotatable within the locking rod groove. Accordingly, the releasing portions of such a non-rotatable sliding locking rod need only be formed on a segment of the rod adjacent the slot.

In a hereinafter described and illustrated embodiment, the upper part of the insert is attached to the holder by means of a locking device, comprising a locking rod groove, a locking rod and engagement formations formed on the insert, according to the invention. The lower part of the insert, on the other hand, is attached to the holder by an engagement formation, in form of an elongated groove along a lower portion of the insert, being positioned over an engagement formation in form of an elongated edge portion of the holder, with the insert in an angled state and subsequently the insert is rotated to its fully inserted position. However, it should be understood that also the lower part of the insert could be attached to the holder by means of a locking device according to the invention.

In the hereinafter described and illustrated embodiments of the invention, the locking rod groove is arranged close to a border edge of the seating surface of the holder and the engagement formations of the insert are arranged close to a front surface of the insert unit which is adapted to accommodate a coating rod in a coating rod groove and which is adapted to face a web or roller to be coated. It is to be understood however, that the locking rod groove also could be positioned elsewhere in the seating surface of the insert groove as long as the locking portion of the locking rod can engage with or “behind” a suitable formed engagement formation of the insert and ensure secure attachment of the same.

### BRIEF DESCRIPTION OF THE DRAWINGS

The invention will hereinafter be described in detail by reference to the accompanying drawings in which possible embodiments are illustrated by way of example. It is to be understood, however, that many other embodiments are conceivable within the scope of the claims. In the drawings:

FIG. 1 is a schematic cross sectional view of a coating feeder and a metering device according to the invention during coating of viscous coating medium directly onto a moving web;

FIG. 2 is a schematic cross sectional view of a coating feeder and a metering device according to the invention during coating of viscous coating medium indirectly onto a moving web via a transfer roller;

FIG. 3 is a schematic cross section through a holder, an insert, a coating roller and a locking rod, according to a first embodiment of the invention, in a state where the insert and the coating rod are under way to be inserted into the holder;

FIG. 4 is a cross section according to FIG. 3 in a state where the insert is positioned within the insert groove but still not secured to the holder;

FIG. 5 is a cross section according to FIGS. 3 and 4 in a state where the insert is locked by means of the locking rod in the insert groove of the holder;

FIG. 6 is a partly cut through perspective view of the embodiment according to FIGS. 3-5, showing for instance a ratchet mechanism for blocking the locking rod in the locking position and/or the releasing position;

FIGS. 7-8 are perspective views of two conceivable embodiments of locking rods, which can be used in the embodiment of FIGS. 3-5;

FIGS. 9-14 are schematic cross sections through an upper part of the holder, the insert and the locking rod, showing different exemplary embodiments of the locking device according to the invention;

FIG. 15 is a schematic cross section through a holder, an insert, a coating roller and a locking rod, according to a second embodiment of the invention, in a state where the insert and the coating rod are under way to be inserted into the holder;

FIG. 16 is a cross section according to FIG. 15 in a state where the insert is positioned within the insert groove but still not secured to the holder;

FIG. 17 is a cross section according to FIGS. 15 and 16 in a state where the insert is locked by means of the locking rod in the insert groove of the holder;

FIGS. 18-20 are partly cut through perspective views of the embodiment according to FIGS. 15-17;

FIG. 21 is a schematic cross section through a holder, an insert, a coating roller and a locking rod, according to an alternative second embodiment of the invention, in a state where the insert is positioned within the insert groove but still not secured to the holder;

FIG. 22 is a cross section according to FIG. 21 in a state where the insert is locked by means of the locking rod in the insert groove of the holder;

FIGS. 23-24 are partly cut through perspective views of the embodiment according to FIGS. 21-22; and

FIGS. 25-30 are perspective views of five conceivable embodiments of locking rods, which can be used in the embodiment of FIGS. 15-17, FIGS. 18-20 or FIGS. 21-24.

### DETAILED DESCRIPTION OF EMBODIMENTS OF THE INVENTION

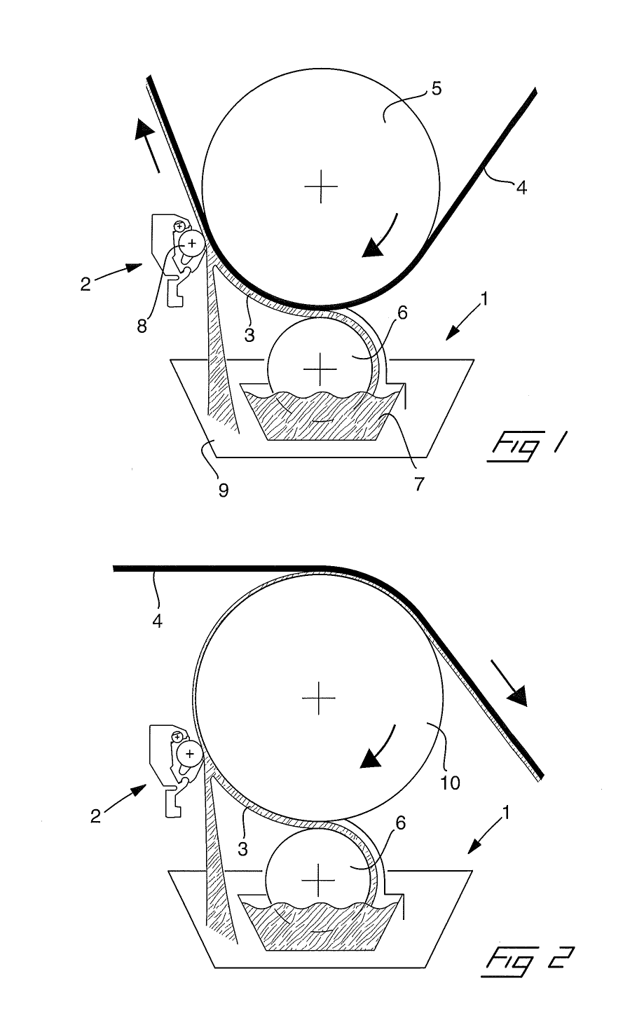

Reference is first made to FIG. 1 in which is schematically illustrated a conceivable arrangement of a coating feeder 1 and a metering device 2, according to the invention, for coating a liquid or viscous coating medium 3 onto a moving web 4, e.g. a paper web. In the illustrated section the web is guided around a rotating web roller 5. The coating feeder is located beneath the web roller and comprises a rotating coating roller 6, which is pressed towards the web and the web roller and of which a lower part is immersed into a coating medium within an inner trough 7. Downstream of the coating roller, as seen in the direction of the moving web roller, the metering device 2 is arranged with a rotating, cylindrical coating rod 8, which is pressed against the web and the web roller. During operation, the coating roller 6 collects coating medium from the inner trough and applies it onto the moving web on the web roller. The amount of coating medium that is applied onto the moving web may be in the order of about 10 to 20 times as much as is desired on the completed web. For this reason the metering device is arranged downstream of the coating feeder to meter the thickness of the layer of coating medium. Normally, this is accomplished by rotating the coating rod in an opposite direction in relation to the moving web. However, it is also possible to let the coating rod rotate with the moving web, as an idle rod, by simply press the coating rod towards the moving web and the web roller. In the latter case, the surface of the coating rod could be patterned, wherein the depth of the pattern as well as the design of the pattern determine the resulting thickness of the layer. The excess coating medium flows from the metering device into an outer trough 9 and can subsequently be recycled into the inner trough. It is to be understood that FIG. 1 is merely a schematic illustration and that the arrangement in reality comprises additional equipment such as for example supporting structures for each of the web roller, the coating feeder and the metering device.

In FIG. 2 is illustrated an alternative application of the coating feeder 1 and the metering device 2. Here the coating medium 3 is applied by means of the coating feeder and metered by means of the metering device on a transfer roller 10. The metered layer of coating medium on the transfer roller is subsequently transferred to the moving web 4, which runs over a portion of the transfer roller 10.

Reference is then made to FIGS. 3-6 for a detailed description of a first embodiment of a metering device according to the invention. The metering device comprises a holder 11 and an insert unit 12 composed of an insert 13 and the coating rod 8. The holder has a robust design with a discharge flange 14 in a lower portion, for guiding the excess coating medium downwards into the outer trough, and an insert groove 15 in a lateral position and in its longitudinal direction for accommodating the insert unit. The inner surface of the insert groove 15 functions as a seating surface 16 for a mating mounting surface 17 on a rear side of the insert. In a front side, which is adapted to face a moving web or a roller, the insert is formed with a coating rod groove 18 in which the coating rod 8 is rotatably received and which surrounds the coating rod over more than 180° of its circumference in order to prevent the coating rod from accidentally be released from the insert. To allow mounting of the coating rod into the coating rod groove, the insert may for example be somewhat resilient to accomplish open up of the coating rod groove and insertion of the coating rod sideways. It could also be possible to slide the coating rod into the coating rod groove from one end of the insert. In a preferred embodiment, the insert unit 12 is delivered in an assembled state with the coating rod 8 installed in the insert 13 since these two components are exposed to the same wear and normally need to be replaced at the same time. In this way the replacement can be facilitated for the user.

In order to allow mounting of the insert 13 and secure attachment in the insert groove 15, the holder 11 is provided with an engagement formation 19 in form of an elongated edge portion having a part circular cross section along the lower portion of the insert groove. The insert is in its turn provided with an engagement formation 20 in form of an elongated groove having a part circular cross section along its lower portion. In this way it is possible to interconnect the lower portions of the insert and the holder by positioning the engagement formation 20 of the insert over the engagement formation 19 of the holder, as is illustrated in FIG. 3, with the insert in a somewhat angled state in relation to its fully inserted position. Subsequently, the insert can be rotated to the fully inserted position, as is illustrated in FIGS. 4 and 5.

To ensure secure attachment of the insert inside the insert groove, a locking device is arranged between the upper parts of the holder 11 and the insert 13. The locking device comprises an elongated locking rod 21, which is rotatably accommodated in the holder inside a locking rod groove 22 formed in the longitudinal direction of the holder. The locking rod groove encloses the locking rod 21 over more than 180° to ensure secure holding of the locking rod inside the locking rod groove 22. The locking rod 21 is adapted to interact with the insert and for this reason, the locking rod groove 22 is formed so close to the insert groove 15 that a slot 23 is formed through the seating surface 16 of the insert groove in the longitudinal direction of the holder such that the slot forms an opening between the locking rod groove and the insert groove. In this way, one or more locking portions 24 of the locking rod will, when the locking rod is rotated to a locking position, engage with one or more engagement formations 25 formed in the mounting surface 17 of the insert, whereas when the locking rod is rotated to a releasing position, one or more releasing portions 26 of the locking rod will coincide with the slot 23 in the seating surface of the holder such that the engagement formations 25 of the insert will be disengaged from the locking rod and the insert can be removed or inserted.

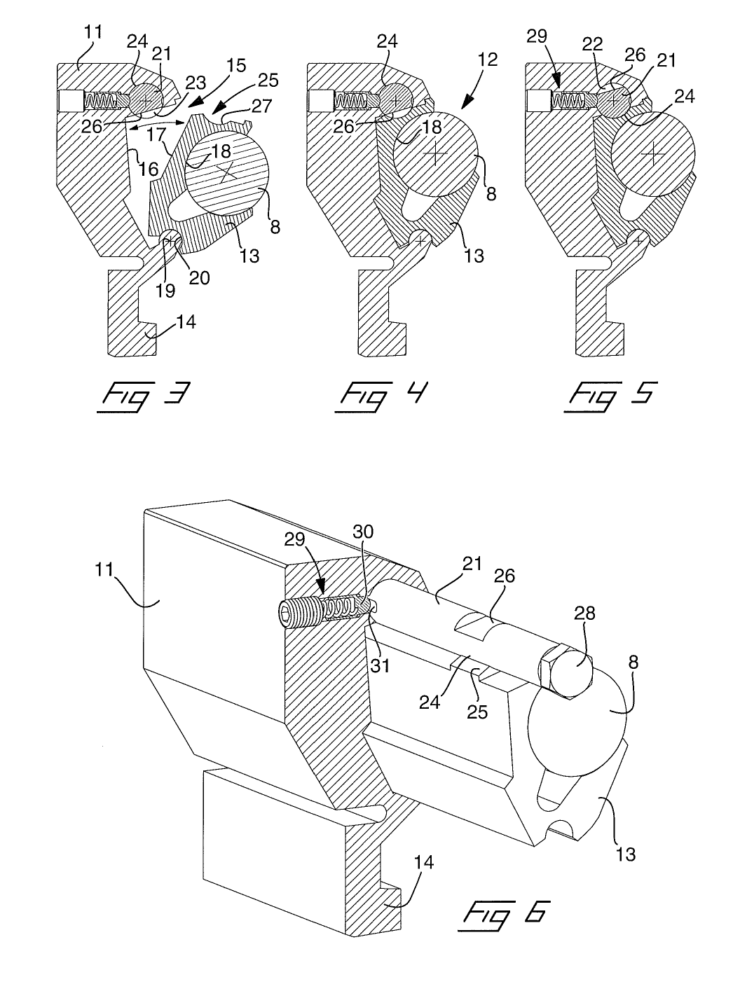

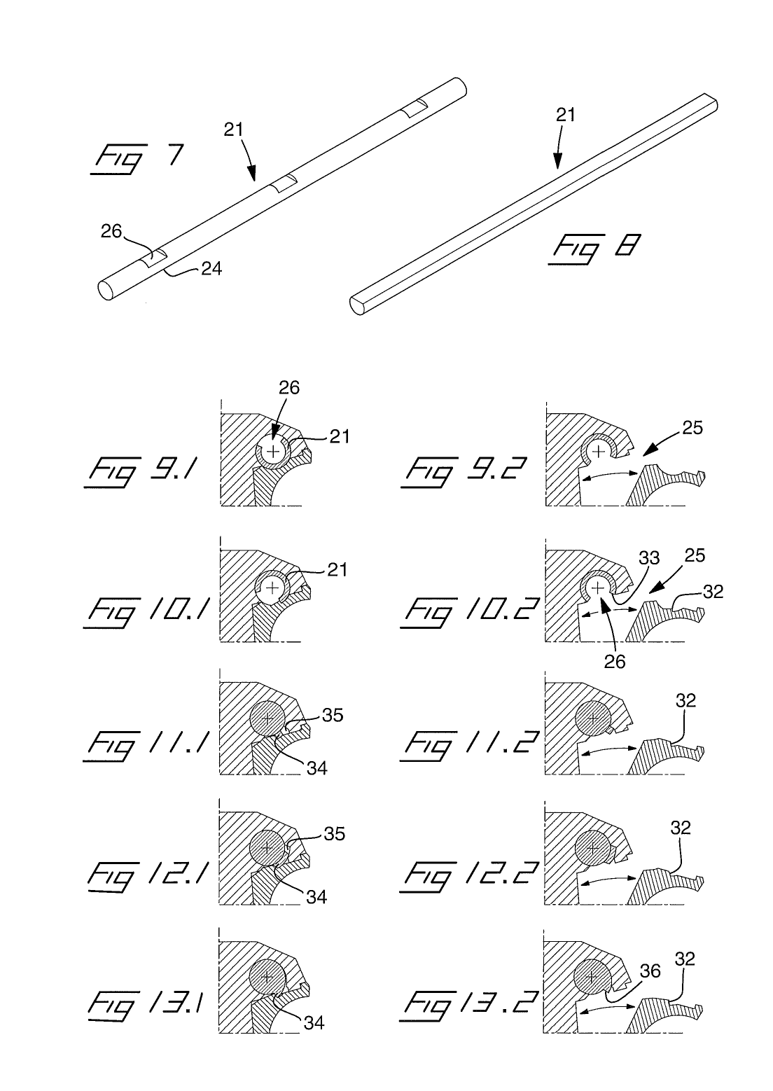

In the first embodiment illustrated in FIGS. 3-6, the locking rod 21 is formed with a generally circular cross section having releasing portions 26 along its length which are recesses having a plane shape, such that the rod in those portions has a generally D-formed cross section. An overall perspective view of the locking rod is depicted in FIG. 7. In this embodiment, the releasing portions 26 of the locking rod 21 are the recessed plane portions, whereas the locking portions 24 are the circular circumference of the locking rod opposite the plane portions. The engagement formations 25 of the insert are raised portions in the upper side of the mounting surface 17, at positions corresponding to the plane releasing portions 26 of the locking rod, and the raised portions are, in an upper surface facing the slot 23 of the locking rod groove 22, formed with part-circular grooves 27 as seen in cross section, which each has a radius of curvature that corresponds to the radius of curvature of the locking portions 24 of the locking rod.

Mounting of the insert and the coating rod in the insert groove of the holder is carried out as illustrated in FIGS. 3-5: In an initial position, according to FIG. 3, the locking rod 21 is in a releasing position having the plane releasing portions 26 coinciding with the slot 23. The engagement formation 20 in the lower portion of the insert 13 is positioned over the corresponding engagement formation 19 of the holder with the insert in a somewhat oblique position. Thereafter, the insert can be pivoted into the insert groove to the position illustrated in FIG. 4. Eventually the locking rod 21 is rotated, preferably 180°, to the position depicted in FIG. 5 such that the part-circular locking portion 26 of the locking rod projects through the slot and into the part-circular grooves 27 of the engagement formation 25 in the mounting surface of the insert, which will securely lock the insert inside the insert groove. The rotation of the locking rod can be performed by means of e.g. a torque wrench or the like engaging at a hexagon head 28 in the end of the locking rod, as illustrated in FIG. 6, or e.g. by operating a handle mounted on the end of the locking rod (not shown in the drawings).

The reference number 29 indicates a ratchet device having a spring actuated ball 30, which can go into engagement with a suitable positioned small recess 31 in the locking rod 21 in order to latch the locking rod at least in the locking position to prevent accidentally releasing of the insert during operation. Preferably, the locking rod is also provided with a recess (not shown in the drawings) positioned to latch the locking rod in the releasing position.

FIGS. 7 and 8 depict two examples of locking rods 21 which may be used in connection with the holder and insert according to FIGS. 3-6. The locking rod according to FIG. 7 is the one that is illustrated in relation to FIGS. 3-6 and is formed as a rod having a circular cross section and an arbitrary number of locking portions 26 in form of plane shaped recesses distributed over the length of the locking rod. The number and positions of the plane shaped recesses have to be co-ordinated with the number and positions of the mating engagement formations on the insert to be used.

It would however also be conceivable to design the locking rod according to the embodiment illustrated in FIG. 8, where the locking rod is formed with a plane surface over its entire length and accordingly is entirely D-shaped in cross section. With an embodiment formed in this way it is not necessary to co-ordinate the design of the locking rod with the number and positions of the engagement formations of the insert and it is even possible to form the insert with a continuous engagement formation over its entire length.

Reference is then made to the FIGS. 9-14 where examples of alternative embodiments of the locking rod and the interacting engagement formation of the insert are illustrated in a locking position and a releasing position, respectively. Throughout the embodiments, the locking portions, the releasing portions and the engagement formations may optionally be intermittently extending or continuously extending over the length of the metering device.

In FIGS. 9.1 and 9.2, the locking rod 21 is formed as a tube having a releasing portion 26 in form of a recess over a part of its circumference. The engagement formation 25 of the insert can in this case have the same shape as in the embodiment of FIGS. 3-6.

In FIGS. 10.1 and 10.2, the locking rod 21 is identical to the locking rod of the embodiment of FIGS. 9.1 and 9.2. However, the engagement formation 25 of the insert is formed with a stop lug 32 adapted to abut an edge 33 of the tube recess in the locking position.

The cross section of a main body of the locking rod according to FIGS. 11.1 and 11.2 is circular and has a locking portion in form of a projecting rib 34, which in the locking position abuts a stop lug 32 at the engagement formation of the insert. To accommodate the stop lug in the releasing position, a recess 35 is formed in the holder at the locking rod groove.

Also the embodiment of FIGS. 12.1 and 12.2 discloses a locking rod having a kind of projecting rib 34, but it is larger than in the previous embodiment and accordingly also the recess 35 in the holder has to be correspondingly larger.

FIGS. 13.1 and 13.2 disclose a kind of projecting rib 34 as well. The difference with this one compared to the previously disclosed is that it is formed with one steep edge 36, to abut against the stop lug in the locking position, and a sloping portion at the other side of a crest of the rib.

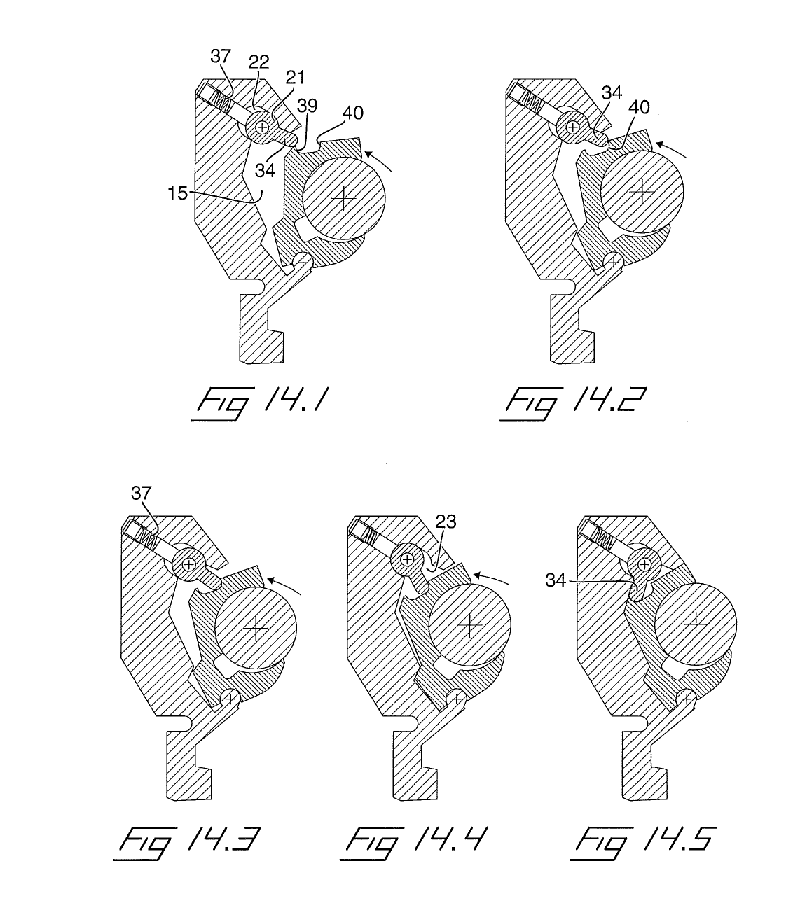

Further, reference is made to the FIGS. 14.1-14.5 in which is disclosed an embodiment of a self locking insert and holder in various mutual positions in relation to each other between a released and a locked position. In this embodiment a main body of the locking rod 21 is circular and is accommodated in a locking rod groove 22 having a cross section which is somewhat larger than the cross section of the locking rod main body, such that the locking rod, besides being rotatable inside the locking rod groove, is radially movable to a certain extent inside the locking rod groove. The locking rod is provided with a projecting rib 34, which is rather long, as seen in cross section, and protrudes through the slot 23 between the locking rod groove 22 and the insert groove 15. Moreover, the holder is provided with a spring member 37, which acts upon the locking rod and urges it towards the slot 23. The engagement formation of the insert is a rather long groove having an inner 39 and outer edge 40. The inner edge is slightly lower than the outer edge such that when the insert is pivoted from the position according to FIG. 14.1 to the position according to FIG. 14.2, the inner edge 39 can pass by the rib 34 of the locking rod, which is urged towards the slot 23 by means of the spring member 37 such that the rib projects through the slot. However, the outer edge 40 will impinge against the rib, as is illustrated in FIG. 14.2. Upon continued pushing inward of the insert from the position in FIG. 14.2, the locking rod will move radially inside the locking rod groove against the action of the spring member 37 to the position of FIG. 14.3 and subsequently to the position of FIG. 14.4, in which the insert and the locking rod reaches a dead centre position. From this position the spring member will push the insert into the fully inserted and locked position according to FIG. 14.5, in which the locking rod is pushed radially by the spring member to the outermost position adjacent the slot 23 inside the locking rod groove and the locking rod is rotated such that the rib 34 is directed inwards and abuts against the inner edge 39 of the engagement groove. Insertion of the insert from the position according to FIG. 14.2 may be performed merely by pushing the insert into the insert groove since the spring member and the rib are approximately aligned with each other in this position. Removal of the insert from the position according to FIG. 14.5, on the other hand, will probably require manually or power-operated rotation of the locking rod since the angle between the spring member and the rib is quite large. For this reason the locking rod can be provided with an engagement formation, for engagement by a suitable tool, or an operating handle in one or both of its ends. This same tool can also be used to lock the insert in the holder instead of pushing the insert in along the length of it.

Reference is now made to FIGS. 15-17 and FIGS. 18-20 for a detailed description of a second embodiment of a metering device according to the invention. The metering device comprises a holder 11 and an insert unit 12 composed of an insert 13 and a coating rod 8. The holder has a robust design with a discharge flange 14 in a lower portion, for guiding the excess coating medium downwards into the outer trough, and an insert groove 15 in a lateral position and in its longitudinal direction for accommodating the insert unit. The inner surface of the insert groove 15 functions as a seating surface 16 for a mating mounting surface 17 on a rear side of the insert. In a front side, which is adapted to face a moving web or a roller, the insert is formed with a coating rod groove 18 in which the coating rod 8 is rotatably received and which surrounds the coating rod over more than 180° of its circumference in order to prevent the coating rod from accidentally be released from the insert. To allow mounting of the coating rod into the coating rod groove, the insert may for example be somewhat resilient to accomplish open up of the coating rod groove and insertion of the coating rod sideways. It could also be possible to slide the coating rod into the coating rod groove from one end of the insert. In a preferred embodiment, the insert unit 12 is delivered in an assembled state with the coating rod 8 installed in the insert 13 since these two components are exposed to the same wear and normally need to be replaced at the same time. In this way the replacement can be facilitated for the user.

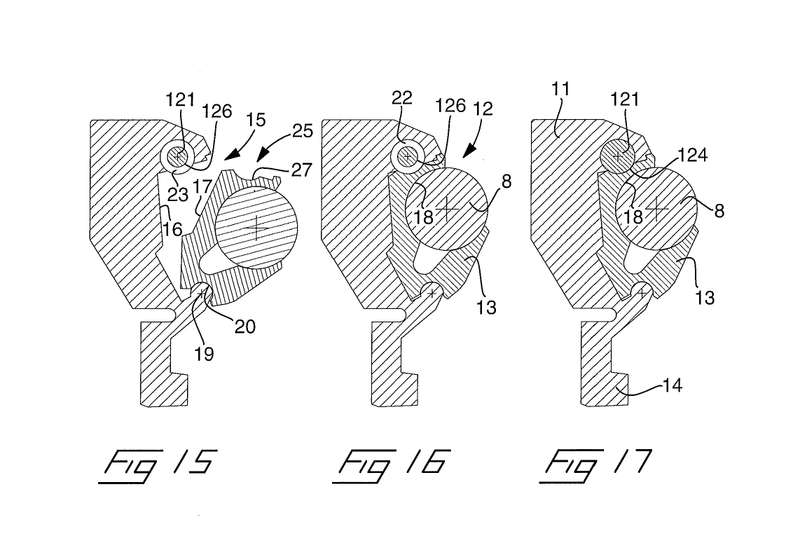

In order to allow mounting of the insert 13 and secure attachment in the insert groove 15, the holder 11 is provided with an engagement formation 19 in form of an elongated edge portion having a part circular cross section along the lower portion of the insert groove. The insert is in its turn provided with an engagement formation 20 in form of an elongated groove having a part circular cross section along its lower portion. In this way it is possible to interconnect the lower portions of the insert and the holder by positioning the engagement formation 20 of the insert over the engagement formation 19 of the holder, as is illustrated in FIG. 15 and FIG. 18, with the insert in a somewhat angled state in relation to its fully inserted position. Subsequently, the insert can be rotated to the fully inserted position, as is illustrated in FIGS. 16-17 and FIGS. 19-20.

To ensure secure attachment of the insert inside the insert groove, a locking device is arranged between the upper parts of the holder 11 and the insert 13. The locking device comprises an elongated locking rod 121, which is accommodated in the holder inside a locking rod groove 22 formed in the longitudinal direction of the holder and which is slidable in the longitudinal direction of the locking rod groove 22. The locking rod groove supports the locking rod 121 to ensure secure holding of the locking rod inside the locking rod groove 22. The locking rod 121 is adapted to interact with the insert and for this reason, the locking rod groove 22 is formed so close to the insert groove 15 that a slot 23 is formed through the seating surface 16 of the insert groove in the longitudinal direction of the holder such that the slot forms an opening between the locking rod groove and the insert groove. In this way, one or more locking portions 124 of the locking rod will, when the locking rod is slid to a locking position, engage with one or more engagement formations 25 formed in the mounting surface 17 of the insert, whereas when the locking rod is slid to a releasing position, one or more releasing portions 126 of the locking rod will coincide with the positions of the engagement formations 25 such that the engagement formations 25 of the insert will be disengaged from the locking rod and the insert can be removed or inserted.

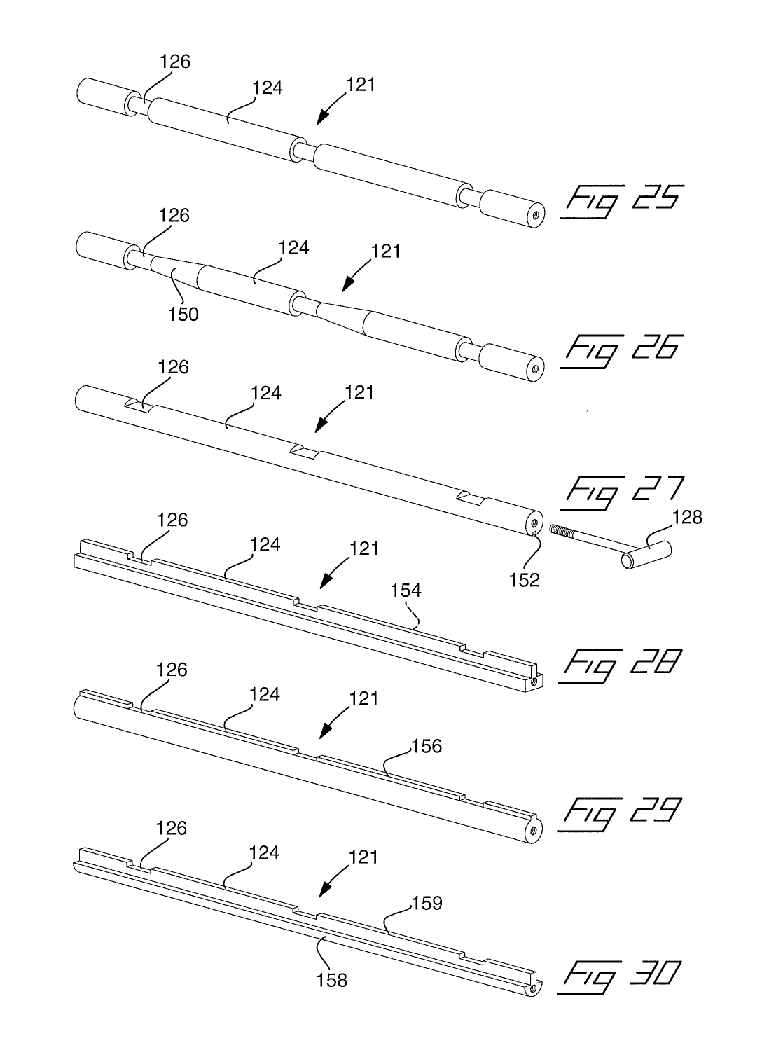

In the second embodiment illustrated in FIGS. 15-17 and FIGS. 18-20, the locking rod 121 is formed with a generally circular cross section having releasing portions 126 along its length which are recesses along the circumference of the locking rod, such that the rod in those portions has a generally circular cross section of a smaller diameter than the main body of the locking rod. An overall perspective view of the locking rod is depicted in FIG. 25. In this embodiment, the releasing portions 126 of the locking rod 121 are the recessed circular portions, whereas the locking portions 124 are the circular circumference of the locking rod between the recessed circular portions. The engagement formations 25 of the insert are raised portions in the upper side of the mounting surface 17, at intervals corresponding to the intervals between the recessed releasing portions 126 of the locking rod, and the raised portions are, in an upper surface facing the slot 23 of the locking rod groove 22, formed with part-circular grooves 27 as seen in cross section, which each has a radius of curvature that corresponds to the radius of curvature of the locking portions 124 of the locking rod.

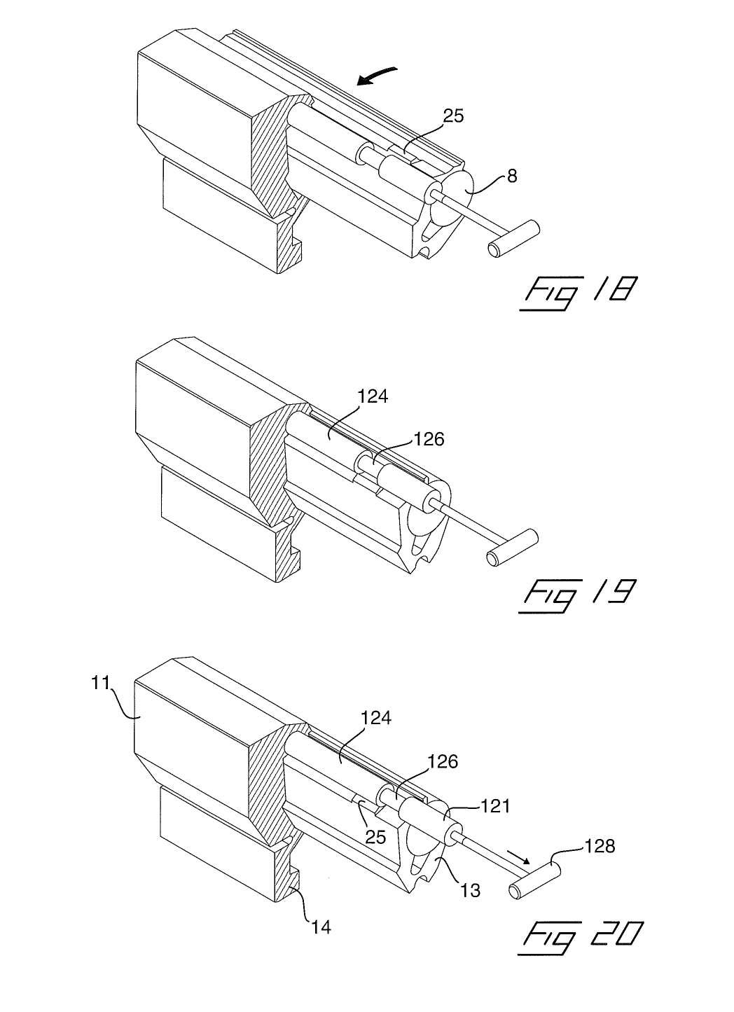

Mounting of the insert and the coating rod in the insert groove of the holder is carried out as illustrated in FIGS. 15-17 and FIGS. 18-20: In an initial position, according to FIG. 15 and FIG. 18, the locking rod 121 is in a releasing position having the recessed releasing portions 126 coinciding with the positions of the engagement formations 25. The engagement formation 20 in the lower portion of the insert 13 is positioned over the corresponding engagement formation 19 of the holder with the insert in a somewhat oblique position. Thereafter, the insert can be pivoted into the insert groove to the position illustrated in FIG. 16 and FIG. 19. Eventually the locking rod 121 is slid, in the longitudinal direction of the locking rod groove, to the position depicted in FIG. 17 and FIG. 20 such that the larger diameter locking portion 126 of the locking rod projects at a position corresponding to engagement formation 25 through the slot and into the part-circular grooves 27 of the engagement formation 25 in the mounting surface of the insert, which will securely lock the insert inside the insert groove. The sliding of the locking rod can be performed by operating a handle 128 mounted on the end of the locking rod, as illustrated in FIGS. 18-20, or by means of e.g. a hydraulic cylinder or the like engaging at the end of the locking rod (not shown in the drawings).

Not shown in the drawings is a ratchet device having a spring actuated ball, which can go into engagement with a suitable positioned small recess in the locking rod 121 in order to latch the locking rod at least in the locking position to prevent accidentally releasing of the insert during operation. Preferably, the locking rod is also provided with a recess (not shown in the drawings) positioned to latch the locking rod in the releasing position.

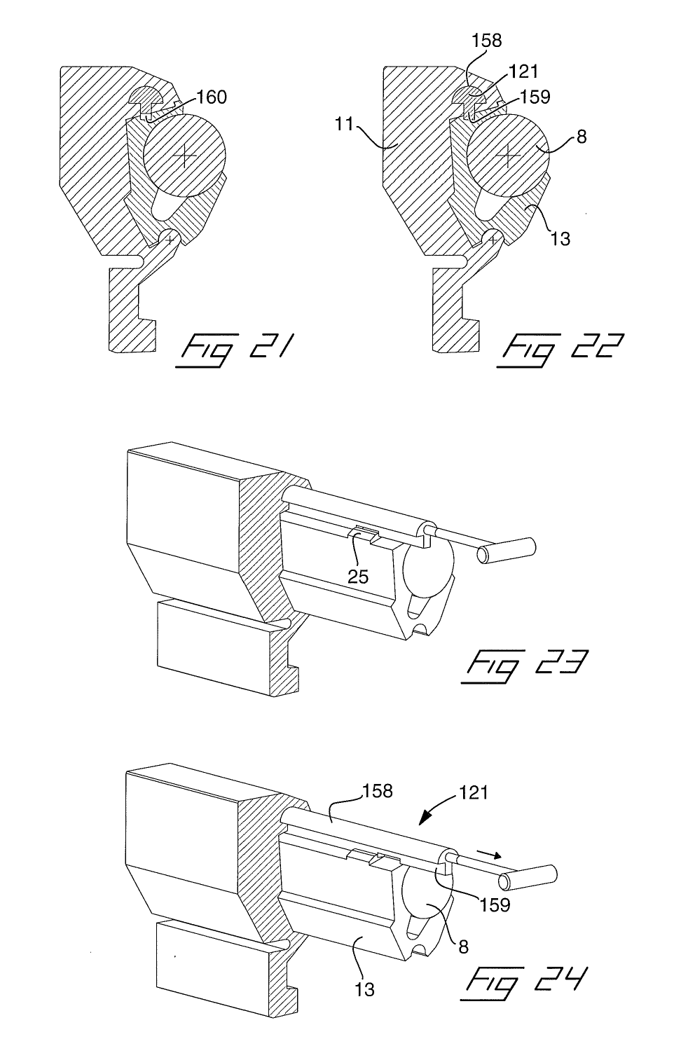

Reference is then made to FIGS. 21-22 and FIGS. 23-24 for a detailed illustration of an alternative example of a metering device according to the invention. This metering device differs from the one depicted in FIGS. 15-20 in that the sliding locking rod 121 is formed with an upper part-cylindrical surface 158 and a rib 159 extending downwards through a slot in the holder and which in the locking position function as locking portions 126 which engages mating engagement formations 25 of the insert. The rib 159 of the locking rod is formed with recesses 160, which function as releasing portions when the locking rod is slid to its releasing position. Unlike the metering device according to FIGS. 15-20, this locking rod cannot be rotated.

FIGS. 25-30 depict six examples of sliding locking rods 121 which may be used in connection with the holder and insert according to FIGS. 15-17, FIGS. 18-20 or FIGS. 21-24. The locking rod according to FIG. 25 is the one that is illustrated in relation to FIGS. 15-17 and FIGS. 18-20 and is formed as a rod having a circular cross section and an arbitrary number of releasing portions 126 in form of recesses along the circumference of the locking rod distributed over the length of the locking rod. The number of and intervals between the recesses have to be co-ordinated with the number of and intervals between the mating engagement formations on the insert to be used. With an embodiment formed this way it is not necessary to prevent rotation of the slidable locking rod.

In FIG. 26, the locking rod 121 has tapered portions 150 linking the larger diameter locking portions 124 and the smaller diameter releasing portions 126. With a locking rod formed in this way sliding of the rod into the locking position is facilitated. The engagement formation 25 of the insert can in this case have the same shape as in the embodiment of FIGS. 15-17.

Another conceivable design is illustrated in FIG. 27, where the locking rod 121 has a circular cross section and an arbitrary number of releasing portions 126 in the form of plane shaped recesses distributed over the length of the locking rod, as well as a guide groove 152 extending along the locking rod and adapted to interact with a guide rib extending along the locking rod groove 22 of the holder. With an embodiment formed in this way the guide groove prevents rotation of the slidable locking rod such that releasing portions formed within a part of the circumference of the locking rod only will be maintained at an angular position allowing interaction with the engagement formations 25.

The locking rod may have a polygonal cross section. In FIG. 28, the locking rod 121 has a T-shaped cross section. The releasing portions 126 are in form of recesses in the leg of the T-shape. The engagement formation 25 of a corresponding insert is formed with a stop lug adapted to abut an edge 154 of the locking rod in the locking position.

The cross section of a main body of the locking rod according to FIG. 29 is circular and has intermittent locking portions 124 in form of projecting ribs 156, which in the locking position abuts a stop lug at the engagement formation of a corresponding insert.

The locking rod according to FIG. 30 is the one that is illustrated in relation to FIGS. 21-24 and is formed with a main body having a part-circular surface 158 and a rib 159 extending from the main body which form the locking portions 124, wherein the rib is formed with recesses which form the releasing portions 126.

### ITEMIZED LISTS OF EMBODIMENTS

### Item 1

An insert for a metering device for coating liquid or viscous coating medium onto a moving material web, the insert being elongated and comprising:

a coating rod groove formed in a longitudinal direction in a front surface of the insert, the coating rod groove being adapted to rotatably support a coating rod having a circular cross section and being designed to surround the coating rod over more than 180° of its circumference;

a mounting surface adapted to be enclosed by a seating surface of an insert groove formed in a longitudinal direction of a holder for holding the insert in a metering device;

one or more engagement formations arranged on the mounting surface and in the longitudinal direction of the insert, the engagement formation being adapted to interact with a locking rod arranged in a locking rod groove in the longitudinal direction of the holder to allow the insert to be inserted into and released from the insert groove when the locking rod is in a releasing position, and to allow secure holding of the insert in the insert groove when the locking rod is in a locking position, in which the engagement formation is in engagement with the locking rod.

### Item 2

An insert according to item 1, wherein the engagement formations are arranged close to the front surface.

### Item 3

An insert according to item 1 or 2, wherein the engagement formations are arranged in an upper portion of the insert.

### Item 4

An insert according to any of the preceding items, also comprising a coating rod inserted into the coating rod groove for forming an insert unit.

### Item 5

An insert according to any of the preceding items, comprising an engagement formation in form of an elongated groove having a part circular cross section along its lower portion.

### Item 6

A holder for a metering device for coating liquid or viscous coating medium onto a moving material web, the holder being elongated and mountable to a frame of the metering device and comprising:

an insert groove in a longitudinal direction of the holder adapted to receive an insert for rotatably supporting a coating rod having a circular cross section, the insert groove being formed with a seating surface adapted to enclose a mounting surface of the insert;

a locking rod groove being parallel to the insert groove and in which a locking rod can be rotatably received, the locking rod groove enclosing an angle of more than 180° and opens into a slot through the seating surface which slot is extending in the longitudinal direction of the holder.

### Item 7

A holder according to item 6, also comprising a locking rod being rotatably received in the locking rod groove and being within a first part of its circumference, at least partly along its length, formed with locking portions and within a second part of its circumference, at least partly along its length, formed with releasing portions, such that when the locking rod is rotated to a locking position, the locking portions will project through the slot, whereas when the locking rod is rotated to a releasing position, the releasing portions will coincide with the slot.

### Item 8

A holder according to items 6 or 7, wherein the locking rod groove is arranged close to a border edge of the seating surface.

### Item 9

A holder according to any of the items 6-8, wherein the locking rod groove is formed with a cross section, which is in part circular or polygonal.

### Item 10

A holder according to any of the items 6-9, wherein the locking rod at least partly is formed with a cross section which is in part circular or polygonal over at least 180° of its circumference.

### Item 11

A holder according to any of the items 6-10, comprising a ratchet mechanism by means of which the locking rod can be latched at least in the locking position.

### Item 12

A holder according to any of the items 6-11, comprising an engagement formation in form of an elongated edge portion having a part circular cross section along the lower portion of the insert groove.

### Item 13

A metering device comprising an insert according to any of the items 1-5 and a holder according to any of the items 6-12.

1. An insert for a metering device for coating liquid or viscous coating medium onto a moving material web, the insert being elongated and comprising:
a coating rod groove formed in a longitudinal direction in a front surface of the insert, the coating rod groove being configured to rotatably support a coating rod having a circular cross section and being designed to surround the coating rod over more than 180° of its circumference;
a mounting surface configured to be enclosed by a seating surface of an insert groove formed in a longitudinal direction of a holder for holding the insert in a metering device;
one or more engagement formations arranged on the mounting surface and in the longitudinal direction of the insert, the engagement formation being configured to interact with a locking rod arranged in a locking rod groove in the longitudinal direction of the holder to allow the insert to be inserted into and released from the insert groove when the locking rod is in a releasing position, and to allow secure holding of the insert in the insert groove when the locking rod is in a locking position, in which the engagement formation is in engagement with the locking rod.

2. An insert according to claim 1, wherein the engagement formations are arranged close to the front surface.

3. An insert according to claim 1, wherein the engagement formations are arranged in an upper portion of the insert.

4. An insert according to claim 1, further comprising a coating rod inserted into the coating rod groove for forming an insert unit.

5. An insert according to claim 1, comprising an engagement formation in form of an elongated groove having a part circular cross section along its lower portion.

6. A holder for a metering device for coating liquid or viscous coating medium onto a moving material web, the holder being elongated and mountable to a frame of the metering device and comprising:
an insert groove in a longitudinal direction of the holder configured to receive an insert for rotatably supporting a coating rod having a circular cross section, the insert groove being formed with a seating surface configured to enclose a mounting surface of the insert;
a locking rod groove being parallel to the insert groove and in which a locking rod can be movably received, the locking rod groove opening into a slot through the seating surface which slot is extending in the longitudinal direction of the holder.

7. A holder according to claim 6, further comprising a locking rod being movably received in the locking rod groove and being formed with locking portions and with releasing portions, the locking portions being configured to project through the slot.

8. A holder according to claim 6, wherein a locking rod can be rotatably received in the locking rod groove and the locking rod groove encloses an angle of more than 180°.

9. A holder according to claim 8, further comprising a locking rod being rotatably received in the locking rod groove and being within a first part of its circumference, at least partly along its length, formed with locking portions and within a second part of its circumference, at least partly along its length, formed with releasing portions, such that when the locking rod is rotated to a locking position, the locking portions will project through the slot, whereas when the locking rod is rotated to a releasing position, the releasing portions will coincide with the slot.

10. A holder according to claim 6, wherein a locking rod can be slidably, in the longitudinal direction of the locking rod groove, received in and supported by the locking rod groove.

11. A holder according to claim 10, further comprising a locking rod being slidably, in the longitudinal direction of the locking rod groove, received in the locking rod groove and being, at least partly along its length, formed with locking portions and, at least partly along its length, formed with releasing portions, the locking portions projecting through the slot.

12. A holder according to claim 11, further comprising an insert for rotatably supporting a coating rod having a circular cross section received in the insert groove and being formed with one or more engagement formations on a mounting surface of the insert, such that when the locking rod is slid to a locking position, the position of the locking portions of the locking rod will coincide with the position of the engagement formation(s), whereas when the locking rod is slid to a releasing position, the position of the releasing portions of the locking rod will coincide with the position of the engagement formation(s).

13. A holder according to claim 6, wherein the locking rod groove is arranged close to a border edge of the seating surface.

14. A holder according to claim 6, wherein the locking rod groove is formed with a cross section, which is in part circular or polygonal.

15. A holder according to claim 6, wherein the locking rod at least partly is formed with a cross section which is in part circular or polygonal over at least 180° of its circumference.

16. A holder according to claim 6, comprising a ratchet mechanism by means of which the locking rod can be latched at least in the locking position.

17. A holder according to claim 6, comprising an engagement formation in form of an elongated edge portion having a part circular cross section along the lower portion of the insert groove.

18. A metering device comprising an insert according to claim 1 and a holder for the metering device for coating liquid or viscous coating medium onto a moving material web, the holder being elongated and mountable to a frame of the metering device and comprising:
an insert groove in a longitudinal direction of the holder configured to receive an insert for rotatably supporting a coating rod having a circular cross section, the insert groove being formed with a seating surface configured to enclose a mounting surface of the insert;
a locking rod groove being parallel to the insert groove and in which a locking rod can be movably received, the locking rod groove opening into a slot through the seating surface which slot is extending in the longitudinal direction of the holder.
